(19) United States
(12) Patent Application Publication
(10) Pub. No.: US 2010/0245042 A1
(43) Pub. Date: Sep. 30, 2010

(54) AUTHENTICATOR AND AUTHENTICATION METHOD

(75) Inventor: Hisayoshi TSUBAKI, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: FUJIFILM Corporation, Tokyo (JP)

(21) Appl. No.: 12/728,554

(22) Filed: Mar. 22, 2010

(30) Foreign Application Priority Data
Mar. 26, 2009 (JP) 2009-076891

(51) Int. Cl. G06F 7/04

(52) U.S. Cl. 340/5.82

(57) ABSTRACT

An authenticator authenticates a person at a cellular telephone according to a registered given user biometrically, in which a predetermined threshold is used in comparison with degree of matching between face images. A location information retriever retrieves information of a first location of the cellular telephone upon retrieval of the person's face image, and a second location of the cellular telephone after detecting the first location at a predetermined time. A movement detector detects whether travel of the cellular telephone occurs upon retrieval of the person's face image according to the first and second locations. A log database unit stores information of the travel from the movement detector. A threshold determining unit determines the threshold according to the information of the travel in relation to one or more earlier event logs of authentication.

### BACKGROUND OF THE INVENTION

1. Field of the Invention

The present invention relates to an authenticator and authentication method. More particularly, the present invention relates to an authenticator and authentication method with which a user of an apparatus can be verified in a reliable manner to prevent fraudulent use of the apparatus.

2. Description Related to the Prior Art

There occur incidents of loss or theft of a cellular telephone, personal digital assistant device (PDA), or other apparatuses which may be a portable apparatus or small electronic apparatus. A stranger holding the apparatus is likely to use the same fraudulently in place of a given user registered to the apparatus. To prevent frauds, a number of techniques of security have been suggested. U.S. Pat. Pub. No. 2007/288,748 (corresponding to JP-A 2007-249585) discloses an authenticator, in which location information of the cellular telephone is retrieved. If protection by face authentication is carried out at a location with a low possibility of presence of the cellular telephone after referring to database for evaluation, then a threshold for the face authentication of a given user is set at a higher level than in a usual condition, to perform the face authentication more strictly.

In the authenticator of U.S. Pat. Pub. No. 2007/288,748 (corresponding to JP-A 2007-249585), there is a drawback of setting the threshold. Let the given user regularly move by vehicular transportation of the railroad or the like every day. If he or she uses the cellular telephone at a specific place such as a railroad station, the threshold is set at a low level at the specific place or near to the specific place even through the given user passes the specific place only in a temporary manner. Should the cellular telephone be stolen by a fraudulent person, and used in the vicinity of the specific place, the person may be authenticated erroneously as the given user, because of the low level of the threshold of the face authentication. This leads to an error in the security of the use of the cellular telephone.

### SUMMARY OF THE INVENTION

In view of the foregoing problems, an object of the present invention is to provide an authenticator and authentication method with which a user of an apparatus can be verified in a reliable manner to prevent fraudulent use of the apparatus.

In order to achieve the above and other objects and advantages of this invention, an authenticator for an apparatus with a variable location for authenticating a person at the apparatus according to a given user registered therewith is provided. There is a biometric authentication device for comparing first biometric information retrieved from the person with second biometric information of the given user stored in storage, to authenticate the person by way of the given user if degree of matching between the first and second biometric information is equal to or higher than a predetermined threshold. A location information retriever retrieves first location information of a first location of the apparatus upon retrieval of the first biometric information, and second location information of a second location of the apparatus before or after retrieving the first location at a predetermined time. A movement detector detects whether travel of the apparatus occurs upon retrieval of the first biometric information according to the first and second location information. A log database unit stores information of the travel and the first location information in response to authentication of the person. A threshold determining unit determines the threshold by reading from the log database unit.

The threshold determining unit reads from the log database unit a number of an event log of the authentication at a location within a reference distance from the first location, and determines the threshold according to the number of the event log and a number of an occurrence of the travel.

The threshold determining unit sets the threshold lower according to smallness of a number of occurrences of the travel.

The threshold determining unit sets the threshold lower according to largeness of the number of the event log of the authentication within the reference distance.

Furthermore, a camera unit photographs a face of the person. The first biometric information is information of a face image produced by the camera unit.

In a preferred embodiment, the first biometric information is any one of fingerprint information of the person, and information of an iris pattern of an eye of the person.

The location information retriever has a GPS receiver for wirelessly retrieving the first and second locations by use of GPS.

The apparatus is a mobile communication terminal or a vehicle.

Also, an authentication method of authenticating a person at an apparatus according to a given user registered therewith is provided. In the authentication method, first biometric information retrieved from the person is compared with second biometric information of the given user stored in storage, to authenticate the person by way of the given user if degree of matching between the first and second biometric information is equal to or higher than a predetermined threshold. Information of a first location of the apparatus upon retrieval of the first biometric information, and a second location of the apparatus before or after retrieving the first location at a predetermined time, is retrieved. It is detected whether travel of the apparatus occurs upon retrieval of the first biometric information according to the first and second locations. Information of the travel from the travel detecting step is stored. The threshold is determined according to the information of the travel in relation to one or more earlier event logs of authentication.

In the storing step, a data table is stored, and is constituted by an event log of the authentication in the comparing step, and a location of the apparatus associated with the event log. In the threshold determining step, the threshold is further determined according to a number of an event log of the authentication in the one or more earlier event logs at a location within a reference distance from the first location.

In the threshold determining step, the threshold is set lower according to smallness of a number of occurrences of the travel.

In the threshold determining step, the threshold is set lower according to largeness of the number of the event log of the authentication within the reference distance.

Also, a computer executable program for authenticating a person at an apparatus according to a given user registered therewith is provided. A program code is for comparing first biometric information retrieved from the person with second biometric information of the given user stored in storage, to authenticate the person by way of the given user if degree of matching between the first and second biometric information is equal to or higher than a predetermined threshold. A program code is for retrieving information of a first location of the apparatus upon retrieval of the first biometric information, and a second location of the apparatus before or after retrieving the first location at a predetermined time. A program code is for detecting whether travel of the apparatus occurs upon retrieval of the first biometric information according to the first and second locations. A program code is for storing information of the travel from the travel detecting program code. A program code is for determining the threshold according to the information of the travel in relation to one or more earlier event logs of authentication.

Consequently, a user of an apparatus can be verified in a reliable manner to prevent fraudulent use of the apparatus, because travel of the apparatus is considered to adjust the threshold in the biometric authentication.

### BRIEF DESCRIPTION OF THE DRAWINGS

The above objects and advantages of the present invention will become more apparent from the following detailed description when read in connection with the accompanying drawings, in which:

FIG. 1 is a perspective view illustrating a cellular telephone;

FIG. 2 is a block diagram illustrating the cellular telephone having an authenticator;

FIG. 3 is a flow chart illustrating a process of authentication; and

FIG. 4 is a flow chart illustrating detection of travel.

### DETAILED DESCRIPTION OF THE PREFERRED EMBODIMENT (S) OF THE PRESENT INVENTION

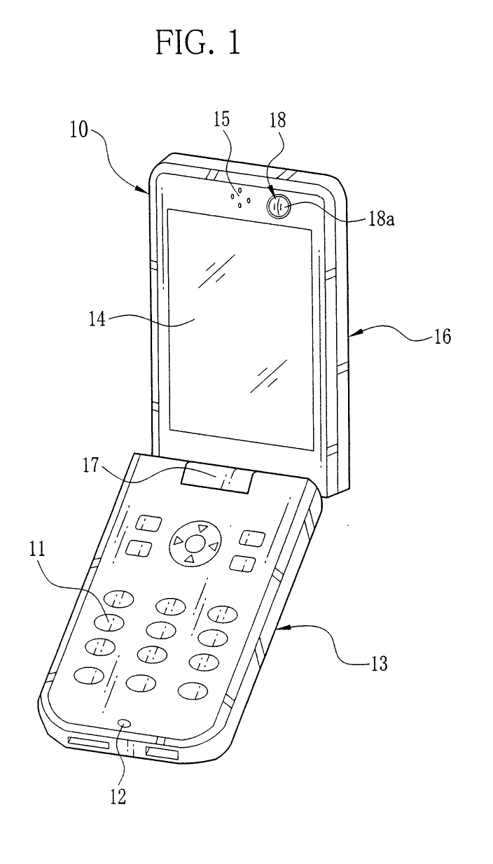

In FIG. 1, a cellular telephone 10 as portable apparatus is illustrated. The cellular telephone 10 includes a main body 13, an earpiece housing 16, and a hinge mechanism 17 for a foldable structure. The main body 13 includes an input panel 11 or keyboard and a microphone 12. The earpiece housing 16 includes a liquid crystal display device 14 or LCD and a speaker 15. The hinge mechanism 17 connects the earpiece housing 16 to the main body 13 in a rotatable manner to define the foldable structure of the cellular telephone 10. A camera unit 18 is contained in an upper portion of the earpiece housing 16. A lens system 18a for image pickup is included in the camera unit 18, and positioned on an inner side of the cellular telephone 10 to be covered internally when the cellular telephone 10 is folded. The camera unit 18 is oriented to pick up an image of a face of a person manually holding the main body 13.

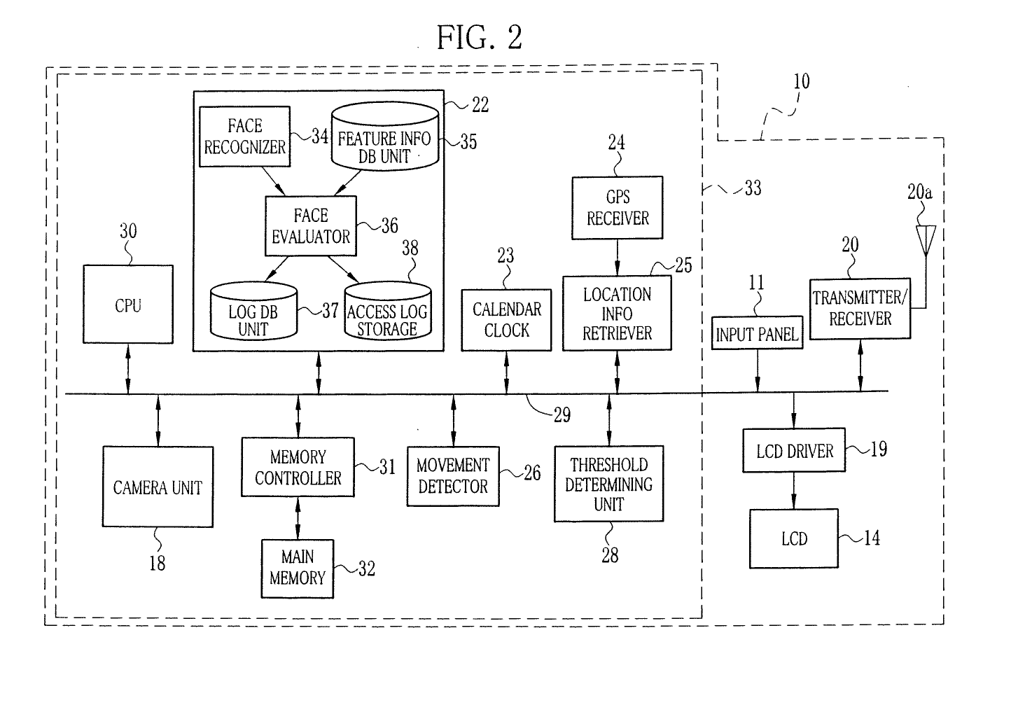

In FIG. 2, the cellular telephone 10 includes the microphone 12, the speaker 15, a transmitter/receiver 20, the input panel 11, the display device 14 and the camera unit 18, and also has a face authentication device or biometric authentication device 22, a calendar clock 23, a GPS receiver 24 or Global Positioning System receiver, a location information retriever 25, a movement detector 26, a threshold determining unit 28, a CPU 30, and a main memory 32. The face authentication device 22 performs biometric authentication of a face image of a person photographed by the camera unit 18. The location information retriever 25 retrieves location information of the cellular telephone 10 according to GPS information from the GPS receiver 24 at each time of face authentication and periodically at an interval of 10 minutes. The movement detector 26 detects whether the cellular telephone 10 travels rapidly or not upon authentication of the face authentication device 22. The threshold determining unit 28 determines a threshold for use in the face authentication device 22 which will be described later. The CPU 30 controls those elements by use of a data bus 29. The main memory 32 is accessed by a memory controller 31 with the CPU 30, and operates for performing tasks according to various data and a control program. An LCD driver 19 drives the display device 14.

An authenticator 33 of the invention is constituted by the camera unit 18, the face authentication device 22, the calendar clock 23, the GPS receiver 24, the location information retriever 25, the movement detector 26, the threshold determining unit 28, the data bus 29, the CPU 30, the memory controller 31 and the main memory 32. Even though the cellular telephone 10 is located in a given place very frequently, it is likely that the cellular telephone 10 only passes the place simply, for example, in the course of regular vehicular transportation of the railroad, as a place of presence with regularly high frequency. Thus, the threshold for use as a reference in the face authentication in the face authentication device 22 is maintained at a high value.

If a given user incidentally loses the cellular telephone 10 in the course of travel, for example, vehicular transportation of the railroad or the like, and if a stranger picks up or steels the cellular telephone 10 and fraudulently uses the same, then protection by authentication is carried out in a strict manner to prevent fraudulent use, because the threshold is as high as an initial threshold in the face authentication device 22 specifically when the person uses the cellular telephone 10 near a railroad station or other place along a path of the vehicular transportation. For presence in a location where the cellular telephone 10 is likely to be stationary or slowly moving without rapid travel, the threshold is set lower than the initial threshold. Erroneous rejection for the given user can be reduced, to maintain easy handling of the cellular telephone 10 for the given user.

In the embodiment, location information is retrieved in the cellular telephone 10 by use of the GPS. However, the location of the cellular telephone 10 can be recognized by retrieving location information of a base station in wireless communication. Also, it is possible to retrieve the location information from an external server. To this end, plural base stations connectable with the cellular telephone 10 can be detected, to retrieve location information of the cellular telephone 10 according to location information of the plural detected base stations.

The camera unit 18 is a small digital still camera, and includes a lens system, aperture stop, image pickup device, signal processor, and the like. Examples of the image pickup device include a CCD image sensor, CMOS (complementary metal oxide semiconductor) image sensor, and the like. In the camera unit 18, the image pickup device photoelectrically converts an optical image of an object into an image signal of an analog form. The signal processor converts the image signal into image data of a digital form, which is transmitted in the data bus 29 and the memory controller 31 to the main memory 32.

The calendar clock 23 measures present temporal information of the year, month, day and time, and inputs the temporal information to the CPU 30. To initialize the calendar clock 23, it is possible for a user to operate the input panel 11 of the main body 13 for entering initial values. Also, the cellular telephone 10 may retrieve temporal information correctly from a time server by means of a base station to initialize the calendar clock 23 automatically.

The CPU 30 controls the entirety of the various elements incorporated in the cellular telephone 10. The CPU 30 loads the main memory 32 with the control program stored in data storage such as a ROM, flash memory or the like (not shown), and performs various tasks.

The transmitter/receiver 20 communicates with a base station wirelessly in a cellular telephone system. The transmitter/receiver 20 converts communication data or voice or the like from the CPU 30 into a radio wave signal of a format suitable for wireless communication. A communication antenna 20a of the transmitter/receiver 20 transmits the radio wave signal to the base station. Also, the transmitter/receiver 20 converts the radio wave signal to communication data after reception with the communication antenna 20a, and inputs the data to the CPU 30.

The face authentication device 22 includes a face recognizer 34 or biometric recognition device or analyzer, a feature information database unit 35 or DB, a face evaluator 36 or biometric evaluator, a log database unit 37 or DB, and an access log storage 38. The face recognizer 34 reads image data of an image frame from the main memory 32, analyzes the same, and retrieves a face image from the image frame as a target of image recognition. The face recognizer 34 extracts face feature information from the face image. Examples of methods of the retrieval of the face image include detection of an area of flesh color, detection of a profile of the face, detection of feature points of the face, and other known techniques of face recognition. Examples of face feature information includes a shape of a profile of the face, a color of a skin, a position of eyes, a shape of the eyes, a color of irises of the eyes, a position of a nose, a shape of the nose, a position of lips, a shape of the lips, a position of hair, a shape of the hair, and a color of the hair.

The feature information database unit 35 previously stores face feature information of a given user required for face authentication. The face evaluator 36 utilizes a known technique of the face authentication, calculates degree of matching of the face feature information obtained by the face recognizer 34 to the face feature information of the given user stored in the feature information database unit 35, and compares the degree of matching with a predetermined threshold. Examples of techniques of the face authentication include an eigenface method, local feature analysis method (LFA), graph matching method, neural network method, constrained mutual subspace method, perturbation space method, and frequency analysis method.

The face evaluator 36, if the degree of matching is equal to or higher than the threshold, determines that the person of the image is the given user, and if the degree of matching is lower than the threshold, determines that the person of the image is different from the given user. For authentication, an initial threshold is the highest threshold. An adjusted threshold is set lower than the initial threshold by the threshold determining unit 28 according to the number of authentication event logs (See Table 3).

The log database unit 37 stores information of Table 1 below. The information includes a calendar date dataset (year, month, day) and a clock time dataset (hour, minute and second) as temporal information at the time of properly performed authentication of a detected face as a face of the given user in the face evaluator 36, a longitude (east longitude) and latitude (north latitude) as location information (arcsecond for each of the both), and detected travel of the cellular telephone 10. Note that the detected travel is according to an output of the movement detector 26 described later. In Table 1, a sign o designates an occurrence of travel.

TABLE 1

| | Date and | Longitude | Latitude | Detected |
|---|---|---|---|---|
| Event No. | time | (east) | (north) | travel |
| 1 | 2009:03:28 | 139.42.56.952 | 35.39.35.964 | x |
| | 21:30:35 | | | |
| 2 | 2009:03:29 | 139.42.56.867 | 35.39.36.193 | x |
| | 19:22:10 | | | |
| 3 | 2009:03:30 | 139.44.33.473 | 35.36.32.275 | x |
| | 12:32:03 | | | |
| 4 | 2009:03:31 | 139.43.40.247 | 35.39.00.823 | ∘ |
| | 07:35:22 | | | |
| 5 | 2009:03:31 | 139.44.33.741 | 35.39.32.210 | x |
| | 12:34:14 | | | |
| 6 | 2009:03:31 | 139.42.56.882 | 35.39.36.213 | x |
| | 20:02:42 | | | |

The movement detector 26 compares a first location of the cellular telephone 10 at the time of authentication in the face evaluator 36 to its second location upon a lapse of a predetermined time, for example 10 minutes. The movement detector 26, if a moving distance is equal to or more than a reference distance, for example 50 meters, determines travel upon the authentication, and if the moving distance is smaller than the reference distance, determines no travel upon the authentication. Information of the travel from the movement detector 26 is written to the log database unit 37.

The access log storage 38 stores information including temporal information of access for authentication irrespective of its properly authenticated status, and information of one of properly authenticated and rejected statuses of the authentication.

Situations of event logs of the authentication are determined according to the temporal information, location information and travel detection. Events Nos. 1, 2 and 6 in Table 1 are found to be authentication of the user at home. Events Nos. 3 and 5 are found to be authentication at his or her office. An event No. 4 is found to be authentication in the course of vehicular transportation.

The moving distance is calculated as follows. At first, a distance difference (Ln) of one arcsecond of latitude is approximately 30.8 meters, which is hereinafter approximated as 31 meters. A distance difference (Le) of one arcsecond of longitude depends on the latitude, and is determined according to the equation below. In the equation, α is the latitude of a first location of authentication. A value of the longitude for use is an average latitude between the first location of authentication and a second location upon lapse of a predetermined time, in order to determine a distance difference (moving distance).

Le=31 (m)×(difference in longitude)×cos α

Let authentication be carried out at the date and time 2009:04:01, 07:33:44. For example, a first location of a person upon the authentication is (139.43.02.728, 35.39.11.538) as (longitude, latitude). Let a second location of the person be (139.43.49.418, 35.38.52.471) after a lapse of a predetermined time. A distance difference L between the first location of the authentication and the second location after the lapse of the predetermined time is obtained as follows.

$$\begin{matrix}Le = 31 \times ( \begin{matrix}139.43 .49 .418 - \\ 139.43 .02 .728\end{matrix} ) \times cos [ ( \begin{matrix}35.39 .11 .538 + \\ 35.38 .52 .471\end{matrix} ) / 2 ] \\ = 31 \times 46.69 \times 0.8125 \\ = 1176 ( m )\end{matrix}$$

$$\begin{matrix}Ln = 30.8 \times ( 35.39 .11 .538 - 35.38 .52 .471 ) \\ = 587 ( m )\end{matrix}$$

Therefore,

$$\begin{matrix}L = \sqrt{{Le}^{2} + {Ln}^{2}} \\ = 1314 ( m ) > 50 ( m )\end{matrix}$$

The distance difference L is larger than the reference distance of 50 meters predetermined for travel detection. Thus, the cellular telephone 10 is found to travel. Data in Table 2 below are written additionally to the log database unit 37. Note that a sign o in the table designates an occurrence of travel.

TABLE 2

| | Date and | Longitude | Latitude | Detected |
|---|---|---|---|---|
| Event No. | time | (east) | (north) | travel |
| 7 | 2009:04:01 | 139.43.02.728 | 35.39.11.538 | ∘ |
| | 07:33:44 | | | |

The threshold determining unit 28 determines a threshold for the degree of matching for use in the face authentication device 22 according to the data read from the log database unit 37 and location information upon the authentication. To this end, the threshold is increased or decreased from the initial threshold. In the embodiment, the initial threshold is set the highest in view of the most strict authentication. For adjustment, the threshold is set lower than the initial threshold. According to highness in the possibility in that the present location is where the cellular telephone 10 is very usually operated, a lower factor than 100% is used for multiplication with the initial threshold.

The threshold determining unit 28 searches and retrieves authentication event logs from the log database unit 37 for authentication in a location at a distance of 50 meters or smaller from the present location for authentication. An LUT (lookup table) of Table 3 is produced to determine a threshold according to the number of the event logs according to the retrieval and the number of occurrences of travel among the authentication event logs (either zero or at least one). The LUT is stored in the threshold determining unit 28.

An example of period of retrieval of the log database unit 37 is three (3) months. An example of the value A in Table 3 is 13, which means a frequency of one or more times of authentication per one week. An example of the value B in Table 3 is 45, which means a frequency of one or more times of authentication for every two (2) days. If the number of event logs is equal to or larger than the reference number A and smaller than the reference number B, the threshold is set at 90%×the initial threshold. If the number of event logs is equal to or larger than the reference number B, the threshold is set at 85%×the initial threshold, because probability of coincidence of the person with the given user of the cellular telephone 10 is sufficiently high according to the large number of event logs of authentication.

TABLE 3

| | Occurrences | |
|---|---|---|
| No. of event logs | of travel | Threshold |
| Any | 1 or more | Initial |
| Smaller than A | 0 | Initial |
| Equal to or larger | 0 | 90% x |
| than A and smaller | | |
| than B | | |
| Equal to or larger | 0 | 85% x |
| than B | | |

In another preferred method, the following equation is used for determining a factor for multiplication with the initial threshold instead of using the reference numbers A and B above.

Factor=Max [(Number of authentication event logs−13)×0.01, 0.85]

wherein the function Max [p, q] is a function to define the larger one of the two values p and q. In a manner similar to the above example, the value of 13 means a frequency of one or more times of authentication per one week. The value of 0.85 is a possible lowest factor in order to prevent an excessive decrease of the threshold.

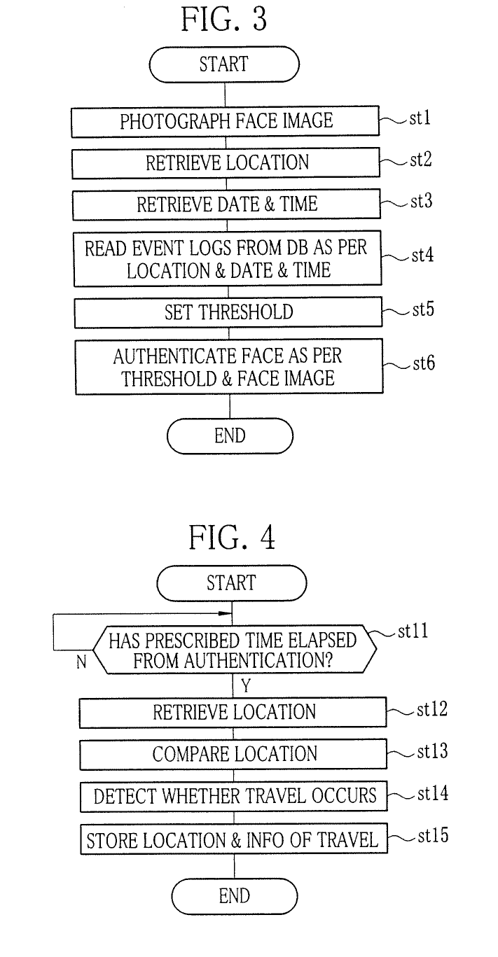

The operation of the cellular telephone 10 is described by referring to FIGS. 3 and 4. When a person depresses any one of keys on the input panel 11 of the cellular telephone 10, the camera unit 18 operates at first. An image frame of a face of the person holding the main body 13 is picked up by the camera unit 18. Image data of the image frame is produced by photoelectric conversion, and written to the main memory 32. The face recognizer 34 reads the image data from the main memory 32, and detects a face image (in step st1) from the image frame by image analysis. The face recognizer 34 extracts face feature information from the face image.

On the other hand, the location information retriever 25 retrieves a location of the cellular telephone 10 from a GPS signal generated by the GPS receiver 24 periodically at 10 minutes. Also, at each time that the camera unit 18 photographs the face of the person, the location information retriever 25 retrieves information of the location of the cellular telephone 10 at the step st2, and writes this to the main memory 32. Also, the calendar clock 23 measures a date and time at present, and inputs temporal information of this to the CPU 30 at the step st3. In response, the CPU 30 sends an instruction signal to the threshold determining unit 28.

The threshold determining unit 28 retrieves a present location and clock time information of the cellular telephone 10 for the clock time in a day by referring to the main memory 32, and also retrieves log information from the log database unit 37 at the step st4, the log information including a number of event logs of earlier authentication in a range within 50 meters from the present location of the cellular telephone 10 substantially at the same clock time (for example, within 5 minutes before and after the clock time), and including the number of occurrences of travel among the event logs. Note that the clock time information in combination with the present location of the cellular telephone 10 is used in place of the temporal information. This is because any temporal information is the unique date and time without plurality, and because a pattern of action of a user is likely to depend upon the clock time.

The LUT of Table 3 above is produced by use of log information retrieved from the log database unit 37, to determine a threshold at the step st5. If the number of occurrences of travel among the authentication event logs is one or more, then the threshold remains at the initial threshold for use in the most strict authentication, because it is supposed that the user has used the cellular telephone 10 in the daily vehicular transportation only at a certain location with low importance.

The face evaluator 36 of the face authentication device 22 compares feature information of a face of the given user stored in the feature information database unit 35 with feature information extracted from the obtained image frame of a face, to produce data of degree of matching, which is compared with the threshold determined by the step st5. If the degree of matching is equal to or higher than the threshold, then a person of the image frame is found identical with the given user in the step st6. If the degree of matching is lower than the threshold, then the person in the image frame is found different from the given user. A result of the face recognition in the face evaluator 36 is written to the log database unit 37 and the access log storage 38.

The CPU 30 responds to the result of the face authentication in the face evaluator 36, and allows free use of the cellular telephone 10 if the person of the image is the given user. The CPU 30, if the person is different from the given user, locks keys on the input panel 11 electrically or mechanically to inhibit operation.

When 10 minutes lapse after the authentication (at the step st11), second location information is retrieved (at the step st12). The second location information is compared with the first location information concurrent with the authentication at the step st13. If there is a difference in the distance equal to or more than 50 meters, then the travel is detected. If not, then no travel is detected. See the step st14. Information is written to the log database unit 37 at the step st15, including temporal information and location information in the course of the authentication, and an occurrence or non occurrence of detected travel.

Note that the length of time used in the step st11 for the lapse from the authentication may be any value, for example five minutes or 15 minutes in place of 10 minutes.

In the embodiment, the travel detection is carried out by comparison with the second location information retrieved upon lapse of 10 minutes after the authentication. However, travel detection can be carried out by comparison with earlier location information retrieved 10 minutes before the authentication. The length of the time can be any value other than 10 minutes according to the purpose.

In the above embodiments, the given user is single. However, two or more given users can be registered with the single telephone in a shared manner, for example an adult and his or her child. Feature information of faces of all the given users can be stored in the database. If a certain person is found different from any of the adult or the child by the method for the face authentication, keys of the input panel 11 are locked and protected from fraudulent use. Furthermore, plural thresholds may be predetermined for combined use of the plural given users.

In the above embodiments, the initial threshold is determined for the authentication most strictly in the face evaluator 36. A threshold lower than the initial threshold is used for a situation where the user is at home, or otherwise stationary or slowly moving. However, an initial threshold may be an intermediate level. A threshold for the authentication can be set both higher and lower than the initial threshold according to required purposes. Furthermore, an initial threshold may be a low level. A threshold for the authentication can be set higher than the initial threshold according to required purposes.

Note that the numerical features of 13 and 45, and 90% and 85% in the above embodiment are only examples. The invention is not limited to those. For example, a factor of 75% may be used in place of 85%.

In the above embodiment, the threshold determining unit retrieves event logs from the log database unit 37 for earlier authentication at a distance equal to or smaller than 50 meters from the location of initial authentication. However, a reference distance for retrieval of event logs may be 100 meters instead of 50 meters. Furthermore, a condition of the retrieval may be not geographical but time-sequential. For example, the threshold determining unit can retrieve event logs from the log database unit 37 for events of authentication from a clock time 30 minutes before the initial authentication to a clock time 30 minutes after the initial authentication.

In the above embodiments, all data in the log database unit are searched for retrieval. However, a valid term of a limited length, for example 1 year, may be defined in data in the log database unit, to narrow a target area of the retrieval. In the above embodiments, there is no consideration of an interval between events of authentication. However, a specific period may be defined, for example 100 days from a newest date and time of authentication. If elapsed time becomes longer than the specific period, it is possible not to read event logs in the log database unit. Furthermore, the log database unit may be automatically initialized by clearing event logs if long time of an inactive state of the cellular telephone 10 without use has passed, for example 3 to 4 months.

In the above embodiments, the authenticator is incorporated in the cellular telephone. However, the authenticator of the invention may be a vehicle or other movable apparatus. The use of the authenticator in a vehicle can achieve an anti-theft purpose, because it is possible to authenticate a driver of the vehicle as its owner. The biometric authentication is face authentication in the above embodiments, but can be authentication of fingerprints, iris patterns of eyes, or other attributes of a user known technically.

Other examples of apparatuses in which the authenticator of the invention may be incorporated include: electronic apparatuses or precision machines, such as a personal digital assistant device (PDA), notebook type of personal computer, portable game machine, musical instrument, portable music player, electronic notebook, IC card, digital camera, industrial machine, and the like; container cases, such as a suitcase, CD case and the like; valuables of small sizes, such as a purse, expensive product of clothing, and the like.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. An authenticator for an apparatus with a variable location for authenticating a person at said apparatus according to a given user registered therewith, comprising:
a biometric authentication device for comparing first biometric information retrieved from said person with second biometric information of said given user stored in storage, to authenticate said person by way of said given user if degree of matching between said first and second biometric information is equal to or higher than a predetermined threshold;
a location information retriever for retrieving first location information of a first location of said apparatus upon retrieval of said first biometric information, and second location information of a second location of said apparatus before or after retrieving said first location at a predetermined time;
a movement detector for detecting whether travel of said apparatus occurs upon retrieval of said first biometric information according to said first and second location information;
a log database unit for storing information of said travel and said first location information in response to authentication of said person;
a threshold determining unit for determining said threshold by reading from said log database unit.

2. An authenticator as defined in claim 1, wherein said biometric authentication device performs comparison periodically at a regular interval.

3. An authenticator as defined in claim 1, wherein said threshold determining unit reads from said log database unit a number of an event log of said authentication at a location within a reference distance from said first location, and determines said threshold according to said number of said event log and a number of an occurrence of said travel.

4. An authenticator as defined in claim 3, wherein said threshold determining unit sets said threshold lower according to smallness of a number of said occurrence of said travel.

5. An authenticator as defined in claim 3, wherein said threshold determining unit sets said threshold lower according to largeness of said number of said event log of said authentication within said reference distance.

6. An authenticator as defined in claim 1, further comprising a camera unit for photographing a face of said person;
wherein said first biometric information is information of a face image produced by said camera unit.

7. An authenticator as defined in claim 1, wherein said first biometric information is any one of fingerprint information of said person, and information of an iris pattern of an eye of said person.

8. An authenticator as defined in claim 1, wherein said location information retriever has a GPS receiver for wirelessly retrieving said first and second location information by use of GPS.

9. An authenticator as defined in claim 1, wherein said apparatus is a mobile communication terminal or a vehicle.

10. An authentication method of authenticating a person at an apparatus according to a given user registered therewith, comprising steps of:
comparing first biometric information retrieved from said person with second biometric information of said given user stored in storage, to authenticate said person by way of said given user if degree of matching between said first and second biometric information is equal to or higher than a predetermined threshold;
retrieving first location information of a first location of said apparatus upon retrieval of said first biometric information, and second location information of a second location of said apparatus before or after retrieving said first location at a predetermined time;
detecting whether travel of said apparatus occurs upon retrieval of said first biometric information according to said first and second location information;
storing information of said travel and said first location information in a log database unit in response to authentication of said person;
determining said threshold by reading from said log database unit.

11. An authentication method as defined in claim 10, wherein said comparing step is carried out periodically at a regular interval.

12. An authentication method as defined in claim 10, wherein in said threshold determining step, a number of an event log of said authentication at a location within a reference distance from said first location is read from said log database unit, and said threshold is determined according to said number of said event log and a number of an occurrence of said travel.

13. An authentication method as defined in claim 12, wherein in said threshold determining step, said threshold is set lower according to smallness of a number of said occurrence of said travel.

14. An authentication method as defined in claim 12, wherein in said threshold determining step, said threshold is set lower according to largeness of said number of said event log of said authentication within said reference distance.
